(19) United States
(12) Patent Application Publication
(10) Pub. No.: US 2008/0062440 A1
(43) Pub. Date: Mar. 13, 2008

(54) Rotary-printing system

(75) Inventor: Klaus Pechtl, Stadtschwarzach (DE)

Correspondence Address: K.F. ROSS P.C., 5683 RIVERDALE AVENUE, SUITE 203 BOX 900, BRONX, NY, 10471-0900, US

(73) Assignee: KBA-METRONIC AG

(21) Appl. No.: 11/899,404

(22) Filed: Sep. 5, 2007

(30) Foreign Application Priority Data
Sep. 5, 2006 (DE) 102006042068.3

(51) Int. Cl. G06K 15/02

(52) U.S. Cl. 358/1.2

(57) ABSTRACT

A starting image is printed on a flat generally circular substrate by first converting Cartesian coordinates of the pixels of the starting image into polar coordinates to create a first intermediate image in polar form. Then, from the first intermediate image, a second intermediate image is made in Cartesian form with the radial position of each pixel of the first image on the Y-axis and the angular position on the X-axis. A size of each pixel of the second intermediate image is adjusted—stretched or compressed—in accordance with its position on the Y-axis and from the adjusted-size pixels a third intermediate image is formed. The pixels of the third intermediate image are brightened to form a fourth intermediate image that is overlain with a gray-scale raster. A raster analysis is done on the fourth image to create a print image that itself is applied to the substrate.

### FIELD OF THE INVENTION

The present invention relates to method of and apparatus for rotary printing. More particularly this invention concerns such a rotary-printing system applicable to CD's, DVD's, or labels for such circular media.

### BACKGROUND OF THE INVENTION

In the printing of flat, in particular circular disk-shaped, articles by use of a freely programmable printing method, the printing is normally done by rotating the substrate to be printed about an axis perpendicular to the printing plane adjacent a print head extending radially with respect to the rotation axis. Such printing of optical data carriers such as CD's or DVD'S, using block printing methods is known, and is described in U.S. Pat. No. 5,806,420.

A freely programmable type of printing is also described in U.S. Pat. No. 6,202,550 and DE 101 27 659. In various embodiments in the two cited documents, the data carriers to be printed are placed in a apparatus in such a way that the data carrier, the holder containing the data carrier, or the print heads in a holder located above the surface to be printed are able to rotate about a central axis.

The surface of the data carrier is then printed in one or more passes by the ink-jet print heads. These ink-jet print heads may be radially displaced as a function of the rotational angle in order to achieve a higher dot resolution, or, when print heads having a small printing width are used, the surface to be printed may be printed in strips. To this end, the droplet frequency of the individual jets is synchronized with the rotational motion of the data carrier or the holder for the data carrier such that a homogeneous effect of the printed image results.

A disadvantage of this system is that such print heads used in the cited patents are not commercially available, or are available only in a small printing width. Commercially available print heads with large printing widths control the nozzles contained therein via a common pulse, so that one print pulse always prints a complete print line transverse to the printing direction.

Since the methods described in the cited documents relate to printing on a rotating disk, for commercially available print heads the print dots are closer together near the rotation axis, resulting in a higher dot density and also a higher color density, since the size of the droplets emitted from each nozzle is essentially the same.

When narrow print heads are used this may be tolerable, but in this case the disk to be printed must be rotated several times, thus significantly increasing the overall printing time. On the other hand, if print heads as described in the cited documents are used, in which each individual nozzle of a print head may be controlled independently of the adjacent nozzles by means of freely selectable electrical signals, high-quality results may be obtained when the print image is processed using software.

However, such heads are not commercially available, since they have an extremely complicated internal structure due to the possibility for individual electrical control for each nozzle, and thus for each element driving this nozzle, and due to the design of the associated ink supply systems that are mechanically and hydraulically decoupled from the adjacent nozzles, so that they are correspondingly expensive to manufacture and therefore are not offered commercially.

### OBJECTS OF THE INVENTION

It is therefore an object of the present invention to provide an improved rotary-printing system.

Another object is the provision of such an improved rotary-printing system that overcomes the above-given disadvantages, in particular that eliminates the referenced disadvantages so that commercially available print heads having a large printing width may be used.

A further object is to provide a method and a apparatus that allow an article, for example a data carrier, in particular a circular disk-shaped data carrier, to be rotary printed by use of a freely programmable printing method, in particular in only one revolution, so that the resulting print resolution and/or print density of the printed image is essentially constant, in particular within narrow tolerances, over the entire image surface, thus creating a homogeneous effect of the printed image for the observer.

Another object of the invention is to refine the method in such a way that a moiré effect is minimized for multicolor printing in consecutive printing stations.

### SUMMARY OF THE INVENTION

A starting image formed of pixels is printed on a flat generally circular substrate by first converting Cartesian coordinates of the pixels of the starting image into polar coordinates to create a first intermediate image in polar form. Then, from the first intermediate image, a second intermediate image is made in Cartesian form where the radial position of each pixel of the first intermediate image is on the Y-axis and the angular position of each pixel is on the X-axis. A size of each pixel of the second intermediate image is adjusted—stretched or compressed—in accordance with its position on the Y-axis and from the adjusted-size pixels a third intermediate image is formed. The pixels of the third intermediate image are brightened to form a fourth intermediate image that is overlain with a gray-scale raster. A raster analysis is done on the fourth image to create a print image that itself is applied to the substrate.

The invention makes use of the fact that print data for the images to be printed, in particular for freely programmable printing, are usually processed in electronic form as files. In most cases the print data are present in the form of a bitmap image. Such an image may form an output image for the method according to the invention, which according to the invention is prepared prior to a printing operation.

If an output image is present as a black-and-white or gray-scale image, the method according to the invention may be carried out directly with this output image. On the other hand, if a multicolor output image is present, this output image or a multicolor intermediate image formed within the scope of the method according to the invention may be split into monochromatic partial color images, and each of these monochromatic partial color images may be further processed according to the invention, and then the partial color print images may be printed over one another to obtain a multicolor print image on the article to be printed.

The essential aspects according to the invention are therefore explained with reference to a monochromatic output image within the scope of this description of the invention. All method steps referenced herein may be analogously applied in an identical manner to the separated color images.

For an output image of the above-described type, each pixel to be printed may be described by one or more bytes that include the coordinates of the particular pixel and its color values. The overall image may generally be structured as a matrix of pixels, or may be converted into such a matrix using known methods, so that the matrix, in particular for an originally unprocessed output image, is based on a rectangular, i.e. Cartesian, coordinate system, and thus the location of each pixel in this output image is specified by its X coordinate and its Y coordinate.

The color information for each pixel, depending on the underlying color model, may be specified, for example, by RGB values for the colors red, green, and blue, or by the CMYK values, preferred in printing applications, for the printing colors cyan (C), magenta (M), yellow (Y), and black (contrast or K). Of course, other color models may be used, depending on requirements. For purely monochromatic images, it is possible that only the color saturation or color density, for example, of the one color is specified.

As long as the image data for an output image has not been processed for a printing operation, each individual pixel is represented by an individual color value, the brightness and tone of which is determined by the combination of the above-referenced color values. Such an image cannot be directly printed using conventional printing methods, since for virtually all printing methods mixed colors and their brightnesses are always composed, of individual adjacent and/or partially superposed print dots.

The actual print dots are generally selected to be smaller than the pixels to be represented, in order to optimally simulate the actual color and brightness value for the observer via the size of the print dots and/or their distribution within the pixel. In particular for conventional printing applications, a white background is always the starting point. It is more or less covered by the printing inks applied, and may be considered as an additional color.

Since practically all printing methods must manage with only a limited number of printable tones, such as the above-referenced CMYK printing method, for example, it is therefore necessary to convert the bitmap image to be printed into a printable binary image that is adapted to the printing method. Since this is usually achieved by means of a raster image process (RIP), this is referred to as “ripping” the image.

An image ripped in this manner has an independent color separation for each color, corresponding to the printing inks used for printing. Regions of differing brightness within the particular color separations are created by a different surface coverage of the corresponding pixel, so that, for example, a pixel having a brightness of 50% may be created by printing half of the pixel with 100% color and leaving the other half with no color, thereby making the white background visible. Thus, the color separations contain only the information about which positions in the image to be printed have been provided with print dots, and thus have a binary character.

As a rule, each color separation also has a higher print dot count than the pixel count of the output image, which results from the requirement of the closest possible simulation of the color and brightness values of the output image in the print image, in particular when the printing method is a purely binary printing method, which is the case, for example, for thermal-transfer printing or most ink-jet printing methods.

These binary printing methods always allow only print dots of the same size to be printed, which for the most optimal representation of the output image in the print image requires a very high number of print dots, as well as a high print dot density in the printing, in order to provide the eye of the observer with the most homogeneous representation of the print image.

In the creation of images to be printed on a given article, consideration is not always immediately given to the fact that only a portion or perhaps none of the pixels may be printable on the article, since they would lie outside the printable regions of the article. Therefore, according to the invention unprintable image regions may be masked from the output image or from one of the intermediate images.

For example, for this purpose the shape and boundaries of the surface of the substrate to be printed, such as a data carrier, may be superimposed as a mask for the output image to be printed in Cartesian coordinates, so that only the regions that are actually to be printed are intermediately stored as new image data for a previously masked output image. Such a mask may also be present as a file that, for example, is linked to the image data by means of a logical function.

If the surface to be printed has a circular shape, for example, with a central circular hole as is customary for a CD or DVD, the masked output image likewise has a circular shape and contains the referenced hole. Regions of the output image that project beyond the substrate are thus removed by means of this mask.

Masking may be performed at any time in the method according to the invention, and therefore is not limited to use directly for the output image. It is possible for masking to be performed only for one of the intermediate images, although masking of the output image is considered to be advantageous, since on the one hand it is not necessary to subsequently process as large a data volume, thus conserving computer time for software or a computer that carries out the method according to the invention, and on the other hand the mask must correspond to the coordinate system used in the respective intermediate image, which entails additional complexity.

For printing about a rotation axis perpendicular to the printing plane, according to the invention the print image is printed not in a rectangular or Cartesian coordinate system in the customary manner, but instead is printed in a polar coordinate system by rotating a print line for a printing method, for example the print line for a thermal-transfer printer or a thermal sublimation printer, or the print head of an ink-jet printer, about a rotation axis perpendicular to the print line of the print head, thereby printing on a surface to be printed.

Since in the following discussion of the principle it is necessary to consider only the relative motion between the article to be printed and the print head, it is naturally also possible for the print head to be stationary, and the article to be printed to rotate about the referenced axis, beneath the print head. In practice it is normally easier to move the substrate than the print head(s).

The rotary nature of the printing results in a number of modifications to and requirements for the image processing that sometimes differ greatly from known image processing, or that go beyond the scope of the invention.

In order to appropriately process the electronic image data for an output image, whether monochromatic or colored, it is therefore proposed in a first step, in particular by use of software, to convert the Cartesian coordinates of each pixel in the output image to polar coordinates, thereby creating a first intermediate image.

This first intermediate image need not be present as an image that is actually observable; rather, for the invention it is important that the image data be appropriately processed, resulting in such a virtual or imaginary first intermediate image.

The conversion may be performed, for example, by calculating the radius and the angle from the rectangular coordinates for each pixel to be printed, starting, for example, from the center point of the subsequent rotary printing, such as the center of a CD. Instead of the Cartesian coordinates previously used, the associated polar coordinates may then be stored for each pixel.

If these data are imaged in a Cartesian coordinate system, with the X axis corresponding to the angle and the Y axis corresponding to the radius of the associated pixel, and the pixel size is held constant corresponding to the output data, it is easily seen that for increasingly smaller radii fewer and fewer pixels are applied, and the gaps between the pixels thus become larger. Such a representation may be present as a virtual representation in a Cartesian coordinate system, and constitutes a second intermediate image according to the invention. It is possible, but not necessary, for the second intermediate image to actually be displayed.

Since adjacent pixels adjoin one another in a seamless manner starting from the output image, the respective pixels in the second intermediate image for the interior radii Rᵢ must each be stretched tangentially, i.e. along the X direction, by the factor RₒRᵢ(Rₒ=radius of the outermost pixel). This results in a closed image, i.e. a third intermediate image in the sense of the invention.

Since the subsequent printing, using an ink-jet print head, for example, is carried out in a Cartesian coordinate system (viewed from the print head), it is also necessary to brighten the pixels thus stretched in order to compensate for the increase in print density resulting from the stretching. A fourth intermediate image is thus created.

The basis for such a procedure becomes clear when one takes into account that each pixel at this point in time is not yet printable, since it still contains a variable gray scale that cannot be directly printed. Instead, for each pixel these analogous gray scales must be converted to a modified pattern composed of a fairly large number of print dots that may be printed according to one of the referenced printing methods. Such a converted image is referred to as a print image.

All of the intermediate images may be present only in virtual form, for example, such as in the form of a file stored on a computer.

Brightening as a function of the radius coordinates may result in brightening in the direction of the radius, in particular in the direction of the print line for a print head, which in rotary printing is oriented radially with respect to the rotation axis. The above-referenced increase in print density resulting from the printing principle may be compensated for at smaller radii by brightening, preferably performed at smaller radii.

The degree of brightening may preferably be a function of the radius coordinates of the respective pixel. For example, this may involve linear brightening, specified by the ratio of the respective radius of an observed pixel to the largest observable radius. Thus, for pixels having a maximum radius Rₒ, for example, no brightening would occur. The particular brightening function may in particular be adapted to the respective print head used.

The degree of brightening may essentially correspond to the linear distortion factor along the radius of the above-referenced pixel distortion, so that, depending on its distortion, the pixel is brighter the smaller the radius Rᵢ. This relationship between distortion and brightness may be linear, or may generally correspond to a mathematical function, or may also be arbitrary, depending on the requirements and the desired print results.

The above-referenced stretching factor may likewise be a function of the radius coordinates of the respective pixel. Stretching has the advantage that a closed, third intermediate image may be created.

With regard to the brightening and stretching/compression of pixels, it is noted that the sequence in which these measures according to the invention are carried out is irrelevant. Thus, according to the invention the brightening may be performed first, followed by the stretching/compression.

According to the invention, a previously generated intermediate image, in particular the fourth intermediate image, may be further processed prior to the actual printing, in particular, adapted to the printing method used and/or converted to a half-tone image. To this end, for the conversion a fourth intermediate image may be overlaid with a raster, for example, referred to below as a gray-scale raster, where the pixels of the fourth intermediate image located, at least partially, in a raster zone can be combined into a pixel to be printed.

Such overlaying is likewise preferably performed only in a virtual manner, i.e. essentially by use of software. The raster may have a checkerboard design, for example. For the subsequent printing process it is preferable to adapt the raster to the printing method, and for the distance from adjacent fields of the raster along the X axis and Y axis to correspond to the respective distance between the individual pixels to be printed, and, for a symmetrical resolution, for the distances in the X and Y directions to be selected having the same value.

It is obvious that in only a few cases is there exactly one pixel for the fourth intermediate image present within the raster fields of the gray-scale raster. Instead, in most cases the individual, possibly partially interlinked, pixels overlap the boundaries between adjacent raster fields. The gray-scale value and/or color value of a pixel to be printed and combined into a raster zone may be determined from the proportional gray-scale/color values of the combined pixels. The pixels to be printed that are defined by the gray-scale raster, i.e. the color values or gray scales of the pixels, may be obtained, for example, as an average value of the proportions of the adjacent and possibly stretched pixels in the second intermediate image that overlap this field, resulting in a print image.

Alternatively, the pixels, may be rearranged within the overlaid gray-scale raster, since this gray-scale raster is adjusted precisely to the printing raster for the subsequent printing. Corresponding to the overlap rate of the particular pixels with respect to adjacent raster fields, it is possible, for example, to only shift the pixel to the adjacent raster field, or to generate new pixels by calculating new pixels at the raster field positions, based on adjacent pixels weighted with the respective percent overlap. Of course, a combination of the two methods may also be used.

The method according to the invention has so far been described for processing a multicolor output image. In a subsequent step it is also possible to carry out the necessary color separation, and by means of ripping, to convert each color separation to a binary half-tone image. On the other hand, if the color separation has already been performed, each partial color image must be processed according to the invention as previously described.

For ripping, depending on the type of printing method ultimately used in the printing process, conversion to half-tone images may be carried out in a different manner.

If a thermal-transfer printing method or a binary ink-jet printing method, for example, is used as the printing method, by means of which only print dots having the same size can be generated, the various tones or gray-scale values to be printed for each individual raster field of the print image may be approximated by a distribution and configuration of equal-sized print dots within a raster field that represents the pixel. The actual printing raster is thus finer than the raster of an intermediate image, in particular of the print image, and a field in the gray-scale raster comprises, for example, a square configuration of print raster dots.

If, for example, the analogous gray-scale or color scale, extending from 0% to 100%, present in a raster field to be printed is approximated by a binary printing method in steps of approximately 1%, each raster field of the gray-scale raster may be designed with a printing raster of 10×10 print dots, for example, so that a total of 10×10+1=101 different surface coverage states of the printed raster field may be produced, i.e. on the one hand the unoccupied state, and on the other hand, a coverage of 1 to 100%.

If, on the other hand, printing methods with variable print dot sizes are used, such as gray-scale ink-jet printing that allows individual print dots of different sizes to be created, the tone or gray-scale value of each individual raster field of the gray-scale raster, and thus each pixel to be printed, may be approximated in each case by a single print dot of corresponding size within the raster field. In this case, at the same time the printing raster may advantageously correspond to the gray-scale raster.

The two methods may be combined, of course, which is particularly advantageous when, using a gray-scale ink-jet printing method, it is possible to create only a limited number of different sizes of print dots.

If, for example, only 7 different sizes of print dots can be created, but approximately 100 different possible gray scales are desired in each pixel. For a square configuration of the printing raster each pixel may be structured with a raster field composed of 4×4 print dots, resulting in 4×4×7+1=113 possible gray scales or color levels for the respective printed pixel.

The selection of a 3×3 printing raster, on the other hand, results in a scale number of 3×3×7+1=64, which may possibly be too low. Of course, non-square printing rasters may also be used, depending on the application.

Of course, without limitation of the applicability of the invention it is also possible to perform the color separation before the pixel averaging operation in the fourth intermediate image, for example to allow a better adaptation of the half-tone images to the original image, and thus to achieve a more homogeneous image effect.

### BRIEF DESCRIPTION OF THE DRAWING

The above and other objects, features, and advantages will become more readily apparent from the following description, reference being made to the accompanying drawing in which:

FIG. 1 is a masked output image;

FIG. 2 is a stretched second intermediate image converted to polar coordinates;

FIG. 3 is shows a brightened image; and

FIG. 4 is a largely schematic view of a printer according to the invention.

### SPECIFIC DESCRIPTION

### Example 1

A monochromatic rectangular image is to be printed on the surface of a CD, the image being present as a digital bitmap file and having pixels that may assume gray-scale values from 0 to 255, 0 being white and 255 black.

In a first step, a mask is applied by computer over the rectangular image format of the output image, the shape of the mask corresponding to the region to be printed, thereby cropping, i.e. masking, the regions outside the printable region of the CD. This results in a circular masked output image 1 having a central circular hole 2 and a circular outer periphery 3 as shown in FIG. 1.

In a second step, the masked output image 1 is then rolled out or rectified by 360 degrees along its circular circumference 3, for example by use of suitable software on a computer, such that all pixels with the exception of those situated on the edge of the hole 2 are stretched along their tangent to the respective circular arc.

This corresponds, on the one hand, to a transformation of the Cartesian coordinates of the pixels to polar coordinates (first intermediate image) and the representation of the pixels in a rectangular coordinate system (second intermediate image), and on the other hand, to the stretching of the pixels (third intermediate image).

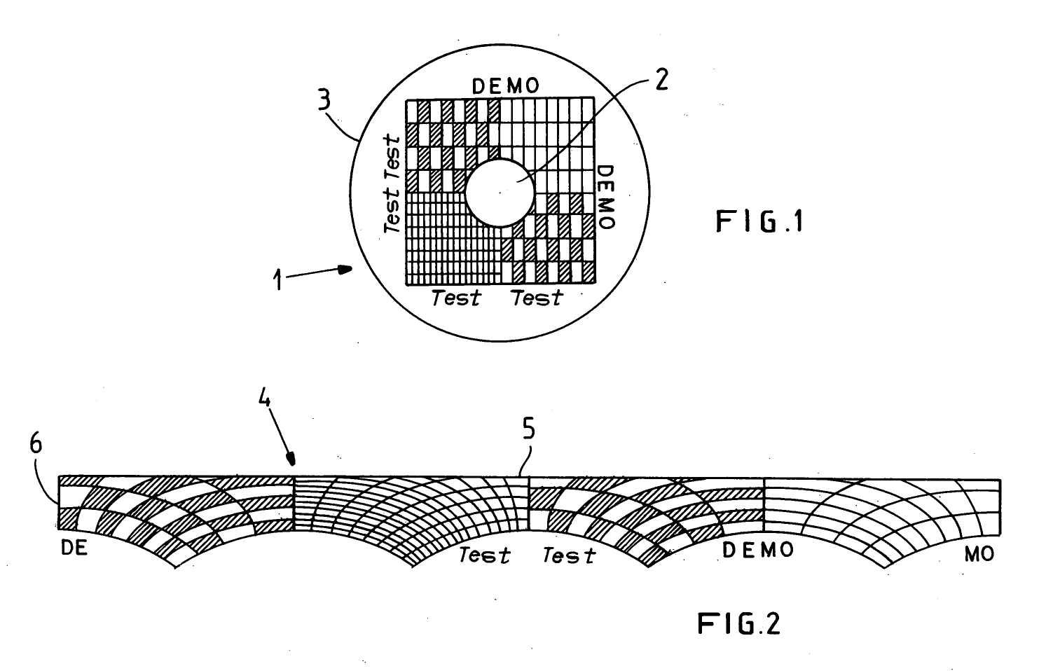

This results in a linearly increasing tangential distortion of the individual pixels inward along the radius, and the resulting image 4 (FIG. 2) has a rectangular shape, the long side 5 of which corresponds to the outer circumference of the previously circular output image 1, and the short side 6 of which corresponds to the radius of the previously circular output image 1, minus the radius of the inner hole 2.

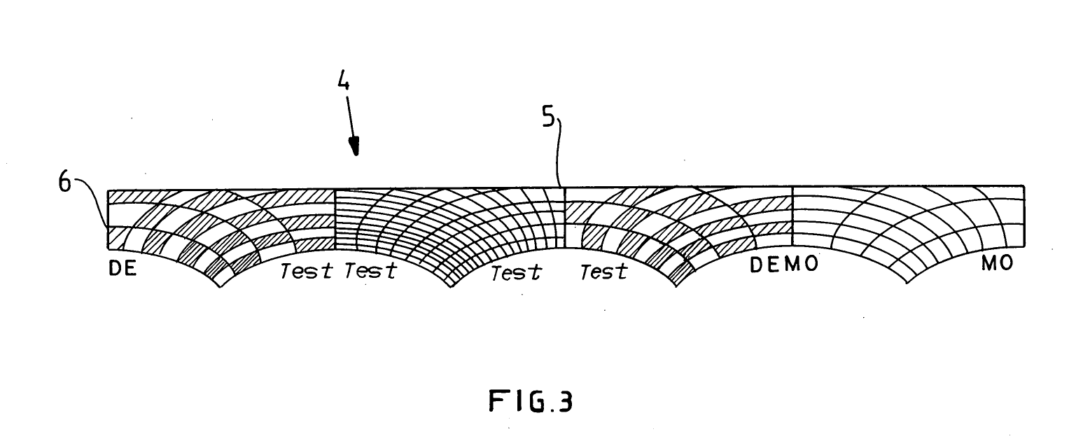

Since in the subsequent printing the print density of the print dots increases radially inward, and thus for a constant print dot size the surface coverage and therefore the gray-scale value of the pixel to be printed would also increase, in a third step a brightening, in a linear manner, for example, is overlaid on the image 4 along the short side 6 as shown in FIG. 3. This results in the fourth intermediate image in the sense of the invention.

Of course, this step may be applied to the image 4 converted to polar coordinates, or even to the output image 1, in which case it is then necessary to perform radial brightening toward the center of the circle, or also to perform such only after one of the subsequent steps, provided that the image has not yet been ripped, since the brightening is still independent of the gray-scale raster and the printing raster used.

In a fourth step a gray-scale raster is then placed over the fourth intermediate image 4 thus created, thereby fixing the printing position of the individual pixels to be printed, resulting in a print image. The gray-scale value of each individual raster line in the gray-scale raster may be obtained as an average of the gray-scale values of the pixels in the fourth intermediate image 4 situated partly or completely in this raster field, and from their respective computer weighting. This results in the print image.

The print image may then be ripped, and the particular half-tone method to be used, i.e. the printing method for the subsequent printing, must be known by this time, at the latest. In this example ink-jet printing is used that operates using gray-scale print heads and that can generate ink droplets in 7 different sizes. Since experience has shown that the human eye cannot distinguish between more than 100 different gray-scale values, instead of the 256 different gray-scale values present in the image data only approximately 100 gray-scale values are printed.

In other words, each pixel of the gray-scale raster to be printed is represented by a 4×4, for example, raster point matrix, resulting in 113 possible different gray-scale values for each subsequently printed pixel.

The conversion of the print image to the half-tone image to be printed therefore occurs in a subsequent fifth step by superimposing a printing raster on the gray-scale raster, thus dividing each raster field of the gray-scale raster into a 4×4 print dot matrix. The gray-scale value of the particular gray-scale value of a raster field for the gray-scale raster to be achieved in the actual printing is then created by printing a corresponding number of fields for the printing raster, and by printing each field of the printing raster to be printed having a print dot of corresponding (possibly different) size. The configuration of the print dots within the selected matrix is arbitrary, and depends only on the software used or the desired result. It may be practical to select a symmetrical configuration in each 4×4 matrix, or to select a statistical distribution of the print dots, for example to minimize a possible moiré effect.

A number from 0 to 7 that represents the print dot size for the respective field of the printing raster may be associated with each field of the printing raster. The number 0 stands for no printing, and the numbers 1 through 7 stand for the corresponding different size of the dot to be printed. The half-tone image thus created is subsequently printed on the surface of the CD in a sixth step by use of the apparatus described below.

### Example 2

A multicolor image is to be printed on the surface of a CD, the image being present as a bitmap file and having pixels that contain multicolor information. In contrast to the procedure described in Example 1, in a further step the image is split into its respective color separations to be printed, resulting in multiple monochromatic images.

Each of the color separation images thus created is further processed in the manner described in Example 1, the distribution of the print dots for each pixel within the respective raster dot matrix being selected such that the color separations successively printed on the CD do not exhibit a moiré effect with respect to one another.

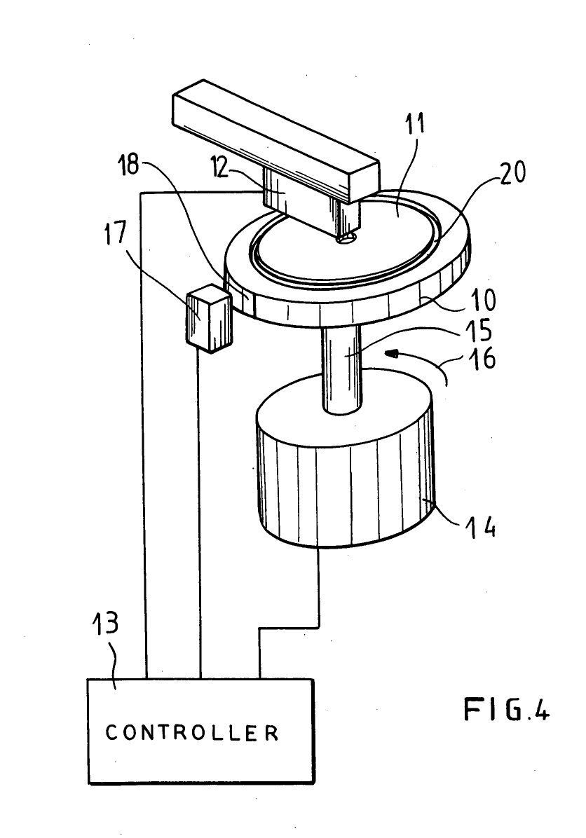

As shown in FIG. 4, the apparatus according to the invention for printing the CD with a print image prepared according to the invention essentially comprises a holder 10 for the data carrier 11 to be printed, a print head 12 located, for example, above the surface to be printed, a controller 13, and a drive 14. For printing, the data carrier 11 to be printed may, for example, be placed in a complementary seat 20 on the holder 10 provided for this purpose. The data carrier 11 may preferably be centered at that location, and by use of suitable devices (not illustrated) may be fixed in place by means of negative pressure (vacuum).

The holder 10 may be designed so that, together with the data carrier 11, it is rotatable about a vertical axis 15 by the drive 14 that rotates in a rotational direction 16 at a normally constant speed set by the controller 13. Starting from a neutral position 18 of the holder 10 detected by a sensor 17, the data carrier 11 is imprinted by the print head 12, which acts on the surface to be printed during rotation of the data carrier. This is achieved by the fact that the particular print dots to be printed are printed, corresponding to the previously created half-tone image, as a function of the instantaneous rotational angle of the holder 10. The instantaneous rotational angle is measured by the sensor 17, and a value representing it is transmitted to the higher-level controller 13, which as a function of the instantaneous position of the holder 10 actuates the print head 12, for example by transferring print dots specified at an angle.

The print head 12 can actually be several such print heads each with a plurality of nozzles that are controlled in a known, customary manner. Thus with each print pulse a number of nozzles or all the nozzles simultaneously are always actuated. A print image prepared according to the invention may preferably be completely printed in a single revolution of the printer with respect to the holder.

In one alternative embodiment, one or more thermal-transfer print heads or thermal sublimation heads may also be used as the printer. Such commercially available print heads are actuated similarly as for the ink-jet print heads described above, so that in this case as well a complete print line or a major portion thereof is always produced by a single print pulse.

1. A method of printing a starting image formed of pixels on a flat generally circular substrate, the method comprising the step of:
a) converting Cartesian coordinates of the pixels of the starting image into polar coordinates and creating a first intermediate image in polar form;
b) forming from the first intermediate image a second intermediate image in Cartesian form where the radial position of each pixel of the first intermediate image is on the Y-axis and the angular position of each pixel is on the X-axis;
c) adjusting a size of each pixel of the second intermediate image in accordance with its position on the Y-axis and forming with the adjusted-size pixels a third intermediate image;
d) brightening the pixels of the third intermediate image and forming with the brightened pixels a fourth intermediate image;
e) overlying the fourth image with a gray-scale raster and performing a raster image processing to create a print image; and
f) printing the print image on the substrate.

2. The printing method defined in claim 1, further comprising the step of
masking the starting image or one of the intermediate images to eliminate portions falling outside the shape of the substrate.

3. The printing method defined in claim 1 wherein the print image is a half-tone image.

4. The printing method defined in claim 1 wherein the half-tone print image has for each zone of the raster a number and size of printable points corresponding to a process used for the printing of the print image.

5. The printing method defined in claim 1 wherein the starting image is in color, the method further comprising the step of
separating the color starting image into a plurality of single-color starting images and thereafter proceeding with steps a) through f) with the separated single-color starting images, using in step f) for each such single-color starting image the respective color.

6. The printing method defined in claim 5 wherein the single-color print images are half-tone images.

7. The printing method defined in claim 1 wherein in step e) a greyscale level of a pixel of the image is determined by the number or position or size of pixels in each of the raster zones.

8. The printing method defined in claim 1 wherein step f) is done by an ink-jet printer.

9. The printing method defined in claim 1 wherein step f) is done by a thermal-transfer printer.

10. The printing method defined in claim 1 wherein step f) is done by a thermal sublimation printer.

11. An apparatus for printing a starting image formed of pixels on a flat generally circular substrate, the apparatus comprising:
control means for
a) converting Cartesian coordinates of the pixels of the starting image into polar coordinates and creating a first intermediate image in polar form;
b) forming from the first intermediate image a second intermediate image in Cartesian form where the radial position of each pixel of the first intermediate image is on the Y-axis and the angular position of each pixel is on the X-axis;
c) adjusting a size of each pixel of the second intermediate image in accordance with its position on the Y-axis and forming with the adjusted-size pixels a third intermediate image;
d) brightening the pixels of the third intermediate image and forming with the brightened pixels a fourth intermediate image;
e) overlying the fourth image with a gray-scale raster and performing a raster analysis to create a print image;
means for holding the substrate and rotating it about a central axis; and
means including a printer juxtaposed with the substrate and connected to the control means for printing the print image on the substrate as it rotates.

12. The printing method defined in claim 1 wherein one of the intermediate images is in color, the method further comprising the step of
separating the one color intermediate image into a plurality of single-color intermediate images and thereafter proceeding with steps a) through f) with the separated single-color intermediate images, using in step f) for each such single-color intermediate image the respective color.
